(19) United States
(12) Patent Application Publication
(10) Pub. No.: US 2025/0343703 A1
(43) Pub. Date: Nov. 6, 2025

(54) BLOCKCHAIN TRANSACTION EXECUTION METHODS AND BLOCKCHAIN NODES

(71) Applicant: Ant Blockchain Technology (Shanghai) Co., Ltd., Shanghai (CN)

(72) Inventors: Minghao YIN, Hangzhou (CN); Dayi Yang, Hangzhou (CN); Zhiyuan Zhou, Hangzhou (CN)

(73) Assignee: Ant Blockchain Technology (Shanghai) Co., Ltd., Shanghai (CN)

(21) Appl. No.: 19/268,387

(22) Filed: Jul. 14, 2025

Related U.S. Application Data
(63) Continuation of application No. PCT/CN2023/135015, filed on Nov. 29, 2023.

(30) Foreign Application Priority Data
May 29, 2023 (CN) 202310612543.8

(51) Int. Cl. H04L 9/00

(52) U.S. Cl. CPC H04L 9/50

(57) ABSTRACT

Provided are blockchain transaction execution methods, apparatuses, computer-readable media and systems. An example method includes: receiving a first transaction, where the first transaction includes a first operation and a second operation, the first operation is used to call a first function in a first contract, and the second operation is used to call a second function in a second contract; and executing the first operation and the second operation.

### CROSS-REFERENCE TO RELATED APPLICATIONS

This application is a continuation of PCT Application No. PCT/CN2023/135015, filed on Nov. 29, 2023, which claims priority to Chinese Patent Application No. 202310612543.8, filed on May 29, 2023, and each application is hereby incorporated by reference in its entirety.

### TECHNICAL FIELD

Embodiments of this specification pertain to the field of blockchain technologies, and in particular, relate to blockchain transaction execution methods and blockchain nodes.

### BACKGROUND

A blockchain is a novel application model of computer technologies such as distributed data storage, peer-to-peer transmission, consensus mechanisms, and encryption algorithms. In a blockchain system, data blocks are sequentially connected in a time sequence and combined into a chain data structure, and distributed ledgers that cannot be tampered with or forged are cryptographically ensured. The blockchain has characteristics such as decentralization, tamper-resistance of information, and autonomy, and therefore the blockchain has received increasing attention and applications.

### SUMMARY

An objective of this application is to provide blockchain transaction methods, to improve efficiency of executing a transaction of calling a contract on a blockchain.

A first aspect of this specification provides a blockchain transaction execution method. The method is executed by a blockchain node and includes: receiving a first transaction, where the first transaction includes a first operation and a second operation, the first operation is used to call a first function in a first contract, and the second operation is used to call a second function in a second contract; and executing the first operation and the second operation.

A second aspect of this specification provides a blockchain node, including: a receiving unit, configured to receive a first transaction, where the first transaction includes a first operation and a second operation, the first operation is used to call a first function in a first contract, and the second operation is used to call a second function in a second contract; and an execution unit, configured to execute the first operation and the second operation.

A third aspect of this specification provides a computer-readable storage medium. The computer-readable storage medium stores a computer program. When the computer program is executed in a computer, the computer is enabled to execute the method according to the first aspect.

A fourth aspect of this specification provides a blockchain node, including a memory and a processor. The memory stores executable code. The processor implements the method according to the first aspect when executing the executable code.

In solutions provided in embodiments of this specification, a transaction that includes a plurality of operations is sent to a blockchain, where each operation corresponds to one contract call, so that a complete service action of a service can be completed in one transaction without dividing the service into a plurality of transactions. In this way, service execution is sped up, costs of completing the service by a user are reduced, and time and storage costs for signing a transaction are also reduced.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram illustrating deploying a smart contract, according to an embodiment;

FIG. 2 is a schematic diagram illustrating calling a smart contract, according to an embodiment;

FIG. 3 is a schematic diagram illustrating a blockchain data storage structure, according to an embodiment;

FIG. 4 is a schematic diagram illustrating a blockchain data storage structure, according to an embodiment;

FIG. 5 is a flowchart illustrating a transaction execution method, according to an embodiment of this specification;

FIG. 6 is a schematic structural diagram illustrating a transaction Tx1 and a signature thereof, according to an embodiment of this specification; and

FIG. 7 is an architectural diagram illustrating a blockchain node, according to an embodiment of this specification.

### DESCRIPTION OF EMBODIMENTS

In order to enable persons skilled in the art to better understand the technical solutions in this specification, the technical solutions in embodiments of this specification would be clearly and completely described in combination with the attached drawings in the embodiments of this specification. Obviously, the described embodiments are only partial embodiments of this specification, not all embodiments. On the basis of the embodiments in this specification, all other embodiments obtained by persons having ordinary skill in the art without creative work shall fall within the scope of protection of this specification.

Blockchains are generally classified into three types: public blockchains, private blockchains, and consortium blockchains. In addition, there are combinations of a plurality of types, such as a combination of a private blockchain and a consortium blockchain, and a combination of a consortium blockchain and a public blockchain. The public blockchain has the highest degree of decentralization. Bitcoin and Ethereum are examples of public blockchains. Participants that join the public blockchain can read data records in the blockchain, participate in transactions, contend for ledger permission of a new block, etc. In addition, each participant (embodied as a node of the participant on the blockchain) can freely join and exit a network and execute related operations. The private blockchain is an opposite of the public blockchain. Write permission of the network is controlled by an organization or an institution, and data read permission is specified by the organization. In short, the private blockchain can be a weakly centralized system, and has few participating nodes with strict restrictions. This type of blockchain is more suitable for internal use of specific institutions. The consortium blockchain varies from the public blockchain to the private blockchain, and can implement “partial decentralization”. Each node in the consortium blockchain usually has a corresponding entity organization or institution. Participants are authorized to join the network and form a stakeholder alliance, and jointly maintain the operation of the blockchain.

Each of the public blockchain, the private blockchain, and the consortium blockchain can provide a function of a smart contract. The smart contract in the blockchain is a contract whose execution can be triggered by a transaction in a blockchain system. The smart contract can be defined in a form of code.

Ethereum is used as an example. Supporting users in creating and calling some complex logic in the Ethereum network is the biggest challenge of Ethereum to be different from the Bitcoin blockchain technology. Ethereum is a programmable blockchain, and the core of Ethereum is an Ethereum virtual machine (EVM). Each Ethereum node can run the EVM. The EVM is a Turing-complete virtual machine, which means that various complex logics can be implemented through it. Deploying and calling smart contracts in Ethereum by users are implemented by the EVM. In fact, the virtual machine directly runs virtual machine code (virtual machine bytecode, referred to as “bytecode” below). The smart contracts deployed on the blockchain can be in the form of bytecode.

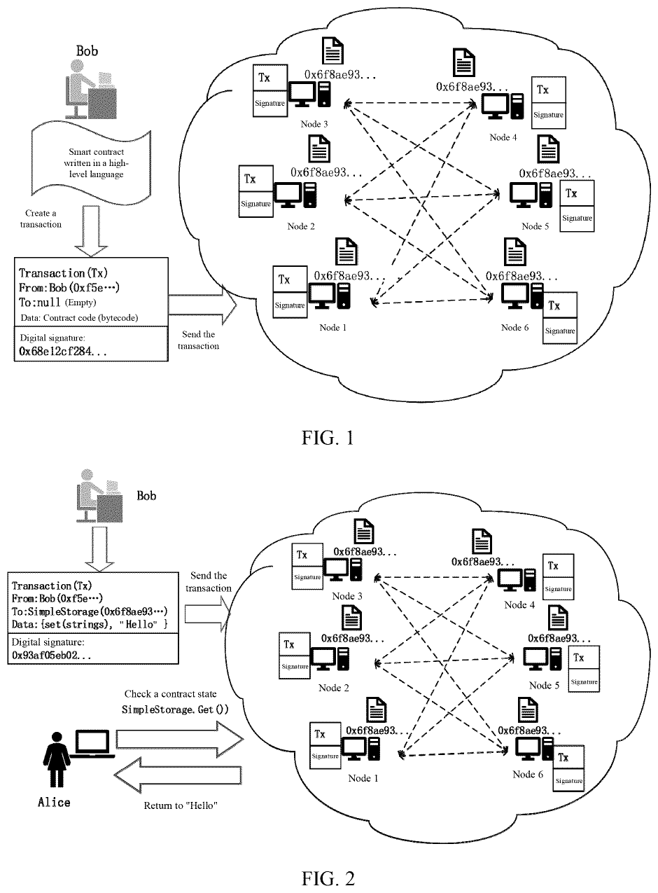

For example, as shown in FIG. 1, after Bob sends a transaction that includes information for creating a smart contract to the Ethereum network, an EVM of a node 1 can execute the transaction and generate a corresponding contract instance. “0x6f8ae93 . . . ” in FIG. 1 represents an address of the contract, a Data field of the transaction can store bytecode, and a To field of the transaction is an empty account. After nodes reach an agreement by using a consensus mechanism, the contract is successfully deployed, and users can call the contract subsequently.

After the contract is successfully deployed, a contract account corresponding to the smart contract appears in the blockchain and has a specific address. Contract code and account storage are stored in the contract account. Behavior of the smart contract is controlled by the contract code, while the account storage of the smart contract keeps a state of the contract. In other words, the smart contract enables the generation of a virtual account on the blockchain that includes the contract code and account storage.

As mentioned above, a data field including creation of a transaction of a smart contract may include bytecode of the smart contract. The bytecode includes a series of bytes, and each byte can identify an operation. Considering the development efficiency, readability, etc., developers can choose a high-level language to write the smart contract code instead of writing bytecode directly. The smart contract code written in the high-level language is compiled by a compiler to generate bytecode, which can be deployed in the blockchain. Ethereum supports many high-level languages, such as Solidity, Serpent, and Lisp-Like Language (LLL).

Solidity is used as an example. Contracts written in Solidity are similar to classes in object-oriented programming languages. A plurality of members (or objects) can be stated in a contract, including a state variable, a function, a function modifier, an event, etc. The state variable is a value that is stored in the account storage of the smart contract, and is used to keep the state of the contract.

The following is a code example 1 of a simple smart contract written in Solidity.

| | |
|---|---|
| 1 | Contract SimpleStorage { |
| 2 | string storedData; |
| 3 | event stored(address from, string s) |
| 4 | function set(string s) { |
| 5 | storedData = s; |
| 6 | stored(msg.sender, s); |
| 7 | } |
| 8 | function get( ) constant returns (string) { |
| 9 | return storedData; |
| 10 | } |
| 11 | } |

### Code Example 1. SimpleStorage Code

In the above-mentioned code example 1, the second row shows a state variable storedData of a string, and the third row shows an event. Content stored associated with the event is the address of an initiator that calls the smart contract and a string s. A set function is defined in fourth to seventh rows. An input parameter is the string s. An operation executed by using the set function includes setting the input parameter to the state variable storedData and generating an event. Content of the event includes calling an initiator address and a string s of the contract.

As mentioned above, the state variable is eventually stored in a database. Eighth to tenth rows define a get function. An operation of the function includes returning a queried storedData value, returns (string) indicates a type of a returned value, and constant modifier identifies that the function cannot modify a value of the state variable in the contract.

In addition, still using Ethereum as an example, as shown in FIG. 2, after Bob sends a transaction that includes information for calling the smart contract to the Ethereum network, the EVM of the node 1 can execute the transaction and generate a corresponding contract instance. A from field of the transaction in FIG. 2 is an address of an account that initiates the call of the smart contract, “0x6f8ae93 . . . ” in a to field represents an address of the called smart contract, and a data field of the transaction stores methods and parameters for calling the smart contract. After the smart contract is called, the value of storedData may change. Subsequently, a certain client device can view a current value of storedData by using a certain blockchain node (such as a node 6 in FIG. 2).

The smart contract can be executed independently by each node in the blockchain network in a prescribed way, and all execution records and data are stored on the blockchain. Hence, when such transactions are completed, transaction vouchers that cannot be tampered with and cannot be lost are stored on the blockchain.

As described above, storedData in the above-mentioned example is a state variable and is stored in the account storage of the smart contract. In various blockchain networks to which smart contracts are introduced, Ethereum is used as an example. Usually, two types of accounts may be included:

Contract account: stores the executed smart contract code and a state value in the smart contract code, and can be usually called and activated only through an externally owned account.

Externally owned account: user account.

A design of the externally owned account and the contract account is actually a mapping from an account address to an account state. The account state usually includes fields such as Nonce, Balance, Storage root, and CodeHash. Nonce and Balance exist in both the externally owned account and the contract account. Attributes of CodeHash and Storage root are usually valid only in the contract account.

Nonce: counter. For the externally owned account, this number can represent a number of transactions sent from the account address. For the contract account, this number can be a number of contracts created by the account.

Balance: account balance.

Storage root: hash of a root node of an MPT. This MPT organizes storage of a state variable of the contract account.

CodeHash: hash value of smart contract code. For the contract account, Codehash is a hash value of a smart contract. For the externally owned account, since a smart contract is not included, the CodeHash field can usually be an empty string/an all-zero string.

A full name of MPT is Merkle Patricia Tree. MPT is a tree structure that combines Merkle Tree and Patricia Tree (compressed prefix tree, a more space-efficient Trie trec). Merkle Trec: A Merkel tree algorithm calculates a Hash value for each transaction, and then a Hash is further calculated based on every two Hash values until a topmost Merkle root is obtained. An improved MPT is used in Ethereum, for example, a 16-ary tree structure, and is also commonly referred to as an MPT.

A data structure of the MPT in Ethereum includes a state trie. The state trie includes a key and value pair (key and value pair, key-value, k-v or kv for short) of storage content corresponding to each account in the Ethereum network. A “key” in the state trie may be an identifier of 160 bits (for example, an address of an Ethereum account or a part of a hash value of an address, hereinafter collectively referred to as an account address). The account address is distributed in storage from a root node to a leaf node of the state trice. A “value” in the state trie is generated by encoding information of the Ethereum account (using a recursive-length prefix (RLP) encoding method). As mentioned above, for the externally owned account, the value includes nonce and balance; and for the contract account, the value includes nonce, balance, codehash, and storageroot.

The contract account is used to store a state related to the smart contract. After a smart contract is deployed on a blockchain, a corresponding contract account is generated. The contract account usually has some states. These states are defined by the state variable in the smart contract, and generate new values when the smart contract is executed. The smart contract is usually a contract that can automatically execute terms and that are defined in code form in a blockchain environment. Once a certain event triggers a term in a contract (an execution condition is satisfied), code can be executed automatically. In the blockchain, a related state of the contract is stored in a storage trie, and a hash value of a root node of the storage trie is stored in storageroot, thereby locking all states of the contract to the contract account by using a hash. The storage trie is also of an MPT structure, and stores key-value mapping from a state address to a state value. After certain information is sequentially arranged from the root node to a leaf node of the storage trie, the result is used to store the address of a state, and the value of the state is stored in that leaf node.

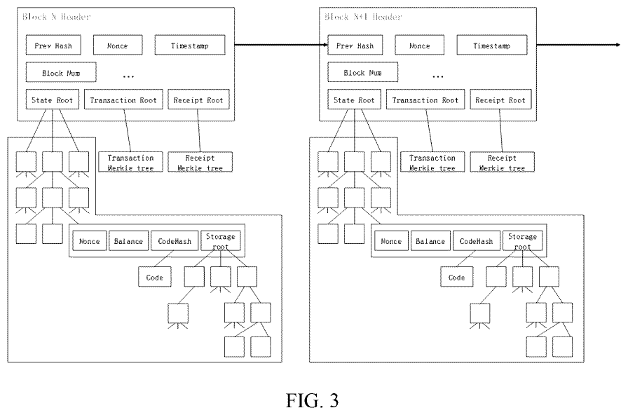

In blockchain data storage shown in FIG. 3, a block header of each block includes several fields, for example, a previous-block hash previous_Hash (Prev Hash in the figure), a random number Nonce (Nonce is not a random number in some blockchain systems, or Nonce in the block header is not enabled in some blockchain systems), a timestamp Timestamp, a block number Block Num, a state root hash State_Root, a transaction root hash Transaction_Root, and a receipt root hash Receipt_Root. Prev Hash in a block header of a current block (for example, a block N+1) points to a previous block (for example, a block N), that is, a hash value of the previous block. In this way, locking of the next block to the current block is implemented in the blockchain through the block header. Here, State_Root, Transaction_Root, and Receipt_Root respectively lock a state set, a transaction set, and a receipt set. The state set, the transaction set, and the receipt set respectively organize states, transactions, and receipts in a tree form. Generally, the tree form may be the same tree structure, or may be different tree structures. For example, the same MPT structure is used in Ethereum. In some tree structures including a state set of a smart contract, for example, Ethereum, a two-level MPT structure is included: A leaf node of an upper-level MPT structure includes two types: an externally owned account and a contract account. Each contract account includes a next-level MPT structure. A lower-level leaf node includes a value of a state in the contract account.

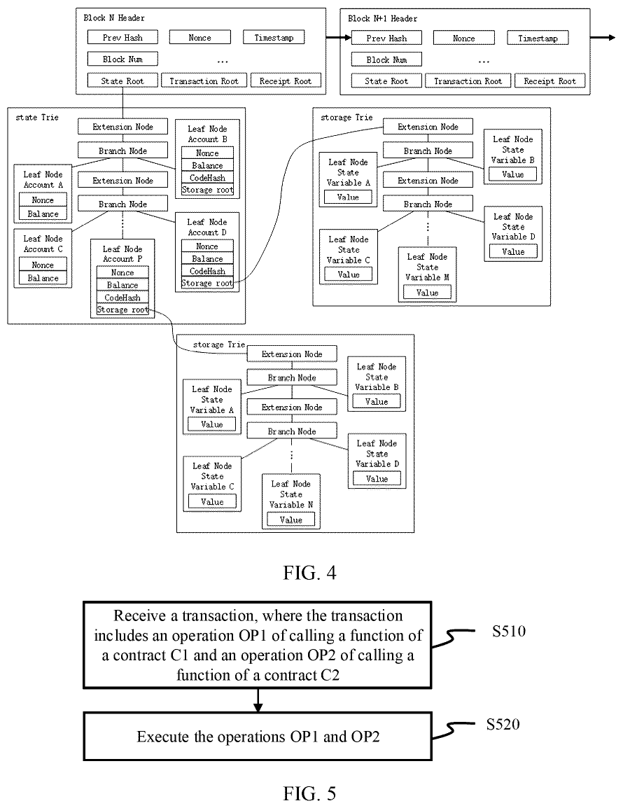

FIG. 4 is a schematic diagram illustrating a blockchain data storage structure. Ethereum is still used as an example. With reference to FIG. 3, state_root is a hash value of a root of an MPT composed of states of all accounts in a current block. In other words, a state trie in an MPT form points to state_root. A root node of the MPT is usually an extension node or a branch node, and state_root usually stores a hash value of the root node. The root node may be connected to one or more lower layers of extension nodes/branch nodes. These layers of tree nodes can be collectively referred to as intermediate nodes. A part of values in each node from the root node to a leaf node of the MPT may be sequentially connected in series to form an account address as a key. Account information stored in the leaf node is a value corresponding to the account address. In this way, a key-value pair is formed. The key may also be a part obtained based on sha3 (Address), that is, a part of a hash value of the account address (for example, a hash algorithm uses a sha3 algorithm). A value stored in the key may be rlp (Account), that is, rlp code of the account information. The account information is a quadruple composed of [nonce, balance, storageRoot, codeHash]. As mentioned above, for an externally owned account, there are usually only two items: nonce and balance. By default, the storageRoot field and the codeHash field store an empty string/all-zero string. In other words, the externally owned account does not store a contract, nor store a state variable generated after a contract is executed. A contract account usually includes Nonce, Balance, Storage root, and CodeHash. Here, Nonce is a transaction counter of the contract account; Balance is an account balance; Storage root corresponds to another MPT, where information about a state related to a contract can be linked to through Storage root; and CodeHash is a hash value of contract code. No matter it is an externally owned account or a contract account, account information is usually located in a separate leaf node. There may be several branch nodes and extension nodes from the extension node/branch node of the root node to a leaf node of each account.

The state trie can be a tree in the MPT form, usually a 16-ary tree. In other words, each layer can have a maximum of 16 child nodes. The extension node is configured to store a common prefix, and usually has one child node. The child node may be a branch node. The branch node can have a maximum of 16 child nodes that may include an extension node and/or a leaf node.

For a contract account in the state trie, storage_Root points to another tree also in the MPT form, and stores data of a state variable related to contract execution. A tree, to which storage_Root points, in the MPT form is a storage trie, where storage_Root is a hash value of a root node of the storage trie. Usually, the storage trie tree also stores a key-value pair. The key indicates an address of a state variable. A value of the key can be a result obtained after processing is performed based on a specific rule on a location where the state variable is declared in a contract (a value counted from 0), for example, sha3 (the location where the state variable is declared) or sha3 (a contact name+the location where the state variable is declared). The value is used to store the value of the state variable (for example, a value obtained through RLP encoding). A part of data stored on a path from the root node to the leaf node through the intermediate node is connected to form a key. The leaf node stores a value. As mentioned above, the storage trie may also be a tree in the MPT form, and is usually a 16-ary tree. In other words, the branch node can have a maximum of 16 child nodes, and these child nodes may include an extension node and/or a leaf node. The extension node can usually have one child node. The child node can be a branch node or a leaf Node.

For example, in FIG. 4, Leaf Node Account P of the state trie is a contract account whose Storage Root locks all states in contract storage. These states are organized as an MPT with a tree structure such as a storage trie linked by Storage Root. In the linked storage trie, Leaf Node State Variable N is used as an example, for example, a value of storedData in the above-mentioned contract code example. In this case, for example, a key can be but is not limited to sha3 (a location where storedData is declared), and a value is s (for brevity, an encoding format for the value is omitted here, for example, RLP, where the following is similar and details are not described). Values of keys are sequentially distributed in the root node to the leaf node (that is, Leaf Node Variable N) of the storage trie.

For another example, in FIG. 4, Leaf Node Account C of the state trie is an externally owned account. A key is sha3 (Address C), that is, a hash value of an address of the account C (for example, a hash algorithm uses a sha3 algorithm), and a stored value may be (Account), where account information Account is a 2-tuple formed by [nonce, balance]. As mentioned above, because Account C is an externally owned account, the account information of Account C includes two items: nonce and balance (codehash and storage root are not included here, where the following is similar). For example, for an externally owned account, nonce is 20, and Balance is 4550; and therefore, nonce=20 and balance=4550 are stored in the leaf node Leaf Node State Variable C. The address of Account C is a key. Values are sequentially distributed in the root node to the leaf node of the state trie (that is, Leaf Node Variable C).

As described above, in a related technology, a transaction includes only a call to a function of a contract, and a service action usually needs to be completed by using a plurality of transactions. Different transactions may call different functions of the same contract or may call functions of different contracts. In this way, each transaction corresponds to one transaction signature, and a plurality of signatures corresponding to a plurality of transactions require longer signature time and higher storage costs.

Embodiments of this specification provide a transaction execution method. In the method, a transaction that includes a plurality of operations is sent to a blockchain, where each operation corresponds to one contract call, so that a complete service action of a service can be completed in one transaction without dividing the service into a plurality of transactions. In this way, service execution is sped up, costs of completing the service by a user are reduced, and time and storage costs for signing a transaction are also reduced.

FIG. 5 is a flowchart illustrating a transaction execution method, according to an embodiment of this specification. The method may be executed by a blockchain node.

As shown in FIG. 5, in step S501, the blockchain node receives a transaction Tx1. The transaction Tx1 includes an operation OP1 of calling a function method1 in a contract C1 and an operation OP2 of calling a function method2 in a contract C2.

A user end of a blockchain can generate the transaction Tx1 and a signature thereof, and send the transaction Tx1 and the signature thereof to the blockchain.

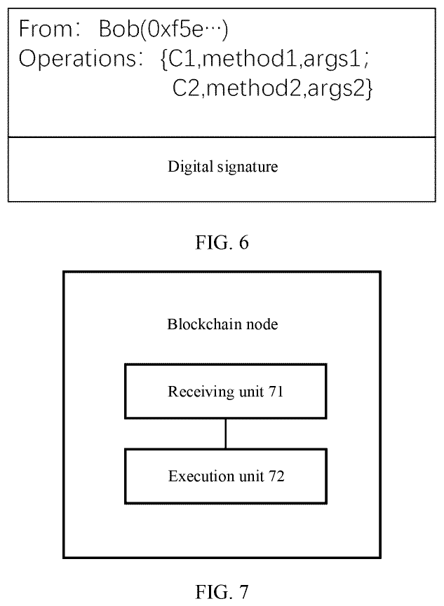

FIG. 6 is a schematic structural diagram illustrating a transaction Tx1 and a signature thereof, according to an embodiment of this specification. As shown in FIG. 6, the transaction Tx1 (that is, a transaction body of the transaction Tx1) can include a From field and an Operations field. The From field indicates an account address of a sender of the transaction. For example, if the sender of the transaction is Bob and an account address of the transaction is 0xf5c . . . , a value of the From field of the transaction Tx1 can be 0xf5e . . . , to indicate that the sender of the transaction is Bob.

The Operations field corresponds to an array. A quantity of elements of the array is not limited. Each element (that is, an operation) of the array includes three fields: a contract address, a method name, and an input parameter value. It can be seen that each operation in the Operations field corresponds to a call to a contract. As shown in FIG. 6, the Operations field of the transaction Tx1 includes two elements: C1, method1, args1 (hereinafter referred to as the operation OP1); and C2, method2, args2 (hereinafter referred to as the operation OP2). The operation OP1 corresponds to a call to method1 in the contract C1, and args1 is an input parameter to method1. The operation OP2 corresponds to a call to method2 in the contract C2, and args2 is an input parameter to method2.

For example, in a service, OP1 is used to call the system contract C1 to create an on-chain account for a user, and OP2 is used to call the NFT contract C2 to transfer NFT resources to the on-chain account created through OP1. In this service scenario, method1 is a function used to create the on-chain account, args1 is an address of the to-be-created account, method2 is a function used to transfer the NFT resources, and args2 is the account address. Alternatively, in another service, OP1 is used to authorize an account by calling a contract, and OP2 is used to call a contract to transfer resources to the authorized account.

It may be understood that different operations in the Operations field can call different functions of the same contract, or may call the same function of the same contract. In addition, a quantity of operations included in the Operations field is not limited to two. There may be three or more operations based on service needs. In embodiments of this specification, two operations are used as an example for description.

In an implementation, when there is no access conflict in contract execution corresponding to different operations in the Operations field, a specific field can be set in the transaction Tx1 to indicate that different operations can be executed in parallel.

In another implementation, different operations are executed in an arrangement sequence of the different operations in the Operations field by default.

In addition to the fields shown in FIG. 6, the transaction Tx1 may further include a timestamp field, a nonce field, a gas_limit field, an extra_data field, etc. The timestamp field indicates a timestamp at which the transaction is sent, the nonce field is used to indicate a nonce value of a sender account of the transaction, the gas_limit field is used to indicate an upper limit of consumed gas of the transaction, the extra_data field indicates other data that needs to be uploaded to the blockchain, etc.

A digital signature of the transaction Tx1 is generated by Bob through digitally signing the transaction body of the transaction Tx1 by using a private key corresponding to an account of Bob. In embodiments of this specification, because one transaction includes a plurality of calls to a contract, only one digital signature is required for the plurality of calls to the contract, instead of signing each call to the contract as in the existing technologies, thereby saving time costs for signing performed by a sender and reducing storage costs of storing signatures in the blockchain.

In step S520, the operation OP1 and the operation OP2 are executed.

Each node in the blockchain can execute the transaction Tx1 after an agreement is reached for the transaction Tx1. When the blockchain node executes the transaction Tx1, in a case that the operation OP1 and the operation OP2 indicated in the transaction Tx1 are executed in parallel, the blockchain node can execute the operation OP1 and the operation OP2 in parallel.

In a case that the operations OP1 and OP2 are executed in an arrangement sequence in the transaction Tx1 by default, the blockchain node first executes the operation OP1, and then executes the operation OP2 in a case that execution of the operation OP1 succeeds. In a case that execution of the operation OP1 fails, the blockchain node determines that execution of the transaction Tx1 fails, and ends execution of the transaction Tx1, that is, no longer executes the operation OP2.

After starting to execute the operation OP2, in a case that execution of the operation OP2 fails, the blockchain node determines that execution of the transaction Tx1 fails, and ends execution of the transaction Tx1.

In other words, when the blockchain node executes the transaction Tx1, if execution of any operation in the transaction Tx1 fails, it can be determined that execution of the transaction fails. Only in a case that execution of each operation in the transaction Tx1 succeeds, it can be determined that execution of the transaction succeeds.

The blockchain node generates a receipt of the transaction Tx1 during execution of the transaction Tx1.

The receipt can include a result field that is used to indicate whether execution of the transaction succeeds. For example, when the result field is 0, it indicates that execution of the transaction succeeds; or when the result field is 1, it indicates that execution of the transaction fails.

The receipt can include output information (Outputs) corresponding to each operation that has been executed. Outputs can be an array. When the result in the receipt is 0, Outputs includes output1 corresponding to OP1 and output2 corresponding to OP2, where output1 and output2 respectively indicate return values of the corresponding operations.

When the result in the receipt is 1, Outputs includes only output information corresponding to an operation that has been executed, where output information corresponding to an operation whose execution fails is used to indicate error information, and output information corresponding to an operation whose execution succeeds is used to indicate a return value of the operation.

In a case that the blockchain node executes OP1 and OP2 in a sequence of OP1 and OP2, output information of operations that have been executed can be arranged in an output information list in the receipt in the sequence of OP1 and OP2. In this case, when the result in the receipt is 1, last output information in the output information list indicates error information, and previous output information indicates a return value of a corresponding operation. For example, when the result is 1, and the output information list includes output1 and output2 respectively corresponding to the operations OP1 and OP2, output represents a return value of the operation OP1, and output2 represents error information of the operation OP2. For example, the error information includes information used to indicate an operation failure, or information used to indicate an insufficient gas value.

In addition, the receipt of the transaction Tx1 can further include an event log (logs) that can include one or more event logs corresponding to operations.

During execution of the operation OP1, for example, the blockchain node can store, in a memory, a variable state written during execution of the operation OP1. For example, “A=V1” indicates that a new state of a variable A is V1, where the variable A is, for example, a variable defined in a contract C1, and a state value of the variable A is stored in a contract state of the contract C1. After the blockchain node starts to execute the operation OP2 after execution of the operation OP1 succeeds, execution of the operation OP2 may include reading the state value of the variable A. For example, the contract C1 is directly called in the operation OP2, or the contract C2 is called in the operation OP2; and the contract C1 is called in the contract C2. The two cases may cause that the operation OP2 includes reading of the variable A. Therefore, the blockchain node reads a stored new state value V1 of the variable A in the executed operation OP1 from the memory, and executes the operation OP2 based on the state value V1.

When the blockchain node determines that execution of the transaction Tx1 fails, a world state modified during execution of the transaction Tx1 is rolled back (discarded). For example, in the above-mentioned example, in a case that execution performed by the blockchain node on the operation OP2 fails, the blockchain node deletes, from the memory, the state “A=V1” that was modified during execution of the operation OP1.

In addition, for the transaction shown in FIG. 6, when analysis of read/write sets is performed on a plurality of transactions to group the plurality of transactions, a read/write set of each operation of a single transaction can be summarized to obtain a read/write set of the transaction, and grouped based on the read/write set of the transaction. In this way, a plurality of transaction groups can be obtained by grouping the plurality of transactions, and the plurality of transactions are executed in parallel.

In the transaction execution method provided in the embodiments of this specification, execution of a transaction is sped up by including a plurality of calls to a contract in the transaction, and execution costs required for the plurality of calls to the contract are also reduced.

FIG. 7 is an architectural diagram illustrating a blockchain node, according to an embodiment of this specification. The blockchain node is configured to execute the method shown in FIG. 5, including: a receiving unit 71, configured to receive a first transaction, where the first transaction includes a first operation and a second operation, the first operation is used to call a first function in a first contract, and the second operation is used to call a second function in a second contract; and an execution unit 72, configured to execute the first operation and the second operation.

Embodiments of this specification further provide a computer-readable storage medium. The computer-readable storage medium stores a computer program. When the computer program is executed in a computer, the computer is enabled to execute the method shown in FIG. 5.

Embodiments of this specification further provide a blockchain node, including a memory and a processor. The memory stores executable code. When executing the executable code, the processor implements the method shown in FIG. 5.

In the 1990s, whether a technical improvement is a hardware improvement (for example, an improvement to a circuit structure, such as a diode, a transistor, or a switch) or a software improvement (an improvement to a method procedure) can be clearly distinguished. However, with development of technologies, improvements in many method processes today can be considered as direct improvements to hardware circuit structures. Almost all designers get the corresponding hardware circuit structure by programming the improved method flow into the hardware circuit. Hence, it cannot say that an improvement of a method flow cannot be implemented using a hardware entity module. For example, a Programmable Logic Device (PLD), such as a Field Programmable Gate Array (FPGA), is such an integrated circuit whose logic functions are determined by the user programming the device. By the designer's own programming to “integrate” a digital system on a PLD, without asking the chip manufacturer to design and produce a special integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. Persons skilled in the art should also know that only by using the above-mentioned hardware description languages to perform a little logic programming on the method flow and programming same into the integrated circuit, the hardware circuit for realizing the logic method flow can be easily obtained.

The controller can be implemented in any appropriate way, for example, the controller may be in the form of, for example, a microprocessor or processor and a computer readable medium, logic gates, switches, an Application Specific Integrated Circuit (ASIC), programmable logic controllers, and embedded microcontrollers, which store the computer readable program code (for example, software or firmware) that can be executed by the (micro) processor. Examples of the controller include, but are not limited to, the following microcontrollers: ARC 625D, Atmel AT91SAM, Microchip PIC18F26K20, and Silicone Labs C8051F320. The memory controllers can also be implemented as part of the memory control logic. It is also known to persons skilled in the art that, in addition to implementing the controller in a purely computer-readable program code manner, it is entirely possible to perform the same functions of the controller in the form of logic gates, switches, ASIC, programmable logic controllers, embedded microcontrollers and the like by logic programming the method steps. Hence, this controller can be considered to be a hardware component, while an apparatus included therein for implementing various functions can also be considered as the structure in the hardware component. Or the apparatus for implementing various functions can even be considered as both a software module for implementing a method and the structure in the hardware component.

The system, apparatus, module, or unit stated in the embodiments above can specifically be implemented using a computer chip or entity, or may be implemented by a product having a certain function. A typical implementing device is a server system. Of course, the present application does not exclude that with the development of computer technology in the future, the computer that implements the functions of the above-mentioned embodiments may, for example, be a personal computer, a laptop computer, a vehicular human-computer interaction device, a cellular phone, a camera phone, a smart phone, a personal digital assistant, a media player, a navigation device, an E-mail device, a game console, a tablet computer, a wearable device, or a combination of any of these devices.

Although one or more embodiments of this specification provide method operating steps as described in an embodiment or a flowchart, more or fewer operating steps may be included on the basis of conventional or noncreative means. The sequence of steps enumerated in the embodiments is only one way among multiple step execution sequences and does not represent a unique sequence of execution. When executed in an actual apparatus or end product, it may be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, and the like are used for indicating names, they do not indicate any particular order.

For the convenience of description, the above-mentioned apparatuses are divided into various modules based on functions for respective descriptions. Of course, when implementing one or more of this specification, functions of various modules can be realized in the same or more software and/or hardware, and the modules that achieve the same function can also be realized by a combination of multiple sub-modules or sub-units. The apparatus embodiments described above are only schematic, for example, the division of units is only a logical function division; in actual implementation, there may be other ways of division; for example, multiple units or assemblies can be combined or can be integrated into another system, or some features can be omitted, or not performed. On the other hand, the coupling or direct coupling or communicative connection between each other shown or discussed may be indirect coupling or communicative connection through some interfaces, apparatuses or units, and may be in electrical, mechanical or other forms.

This application is described with reference to the flowchart and/or block charts of methods, apparatuses (systems), and computer program products according to the embodiments of this application. It should be understood that each process and/or box in a flowchart and/or block chart, and combinations of processes and/or boxes in the flowchart and/or block chart, can be implemented by computer program instructions. These computer program instructions can be provided to processors of a general-purpose computer, a special purpose computer, an embedded processor, or other programmable data processing devices, to produce a machine, so that the instructions executed by the processors of the computer or other programmable data processing devices generate an apparatus for implementing functions specified in one or more processes of a flowchart and/or one or more boxes of a block chart.

These computer program instructions can also be stored in a computer-readable memory that can guide a computer or another programmable data processing device to operate in a particular manner, such that the instructions stored in the computer readable memory produce an article of manufacture including an instruction apparatus, and the instruction apparatus implements the functions specified in the one or more processes of the flowchart and/or the one or more boxes of the block chart.

These computer program instructions can also be loaded to a computer or another programmable data processing device, so that a series of operating steps are executed on the computer or another programmable data processing device, to generate the processing implemented by the computer, and therefore, the instructions executed on the computer or another programmable data processing device provide steps of implementing the functions specified in the one or more processes of the flowchart and/or the one or more boxes of the block chart.

The computer-readable medium includes a persistent and a non-persistent, a removable and a non-removable medium, which implement information storage by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions executed by a computer, for example, a program module. Usually, the program module includes a routine, a program, an object, a component, a data structure, etc. for executing a specific task or implementing a specific abstract data type. The one or more embodiments of this specification can alternatively be practiced in distributed computing environments. In the distributed computing environments, tasks are executed by remote processing devices that are connected through a communication network. In the distributed computing environments, the program module can be located in both local and remote computer storage media including storage devices.

Embodiments in this specification are all described in a progressive manner. For same or similar parts in embodiments, refer to these embodiments. Each embodiment focuses on a difference from other embodiments. Particularly, the system embodiments are basically similar to the method embodiments, and therefore are described briefly. For related parts, references can be made to some descriptions in the method embodiments. In the descriptions of this specification, descriptions of reference to terms such as “an embodiment”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. Moreover, the specific feature, structure, material, or characteristic described may be combined in any suitable manner in any one or more embodiments or examples. Moreover, a person skilled in the art can combine and associate different embodiments or examples and features of different embodiments or examples described in this specification, provided that the embodiments or examples and the features do not conflict with each other.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

What is claimed is:

1. A computer-implemented method, executed by a blockchain node and comprising:
receiving a first transaction, wherein the first transaction comprises a first operation and a second operation, the first operation is used to call a first function in a first contract, and the second operation is used to call a second function in a second contract; and
executing the first operation and the second operation.

2. The computer-implemented method according to claim 1, wherein the first transaction further comprises an arrangement order of the first operation and the second operation, and the executing the first operation and the second operation comprises:
executing, based on the arrangement order, the first operation that is arranged ahead of the second operation; and
in a case that execution of the first operation succeeds, executing the second operation.

3. The computer-implemented method according to claim 2, wherein:
the executing the first operation that is arranged ahead of the second operation comprises: storing an updated first state of a first variable based on the first operation when the first operation is being executed; and
the executing the second operation comprises: in a case that the second operation comprises a read operation for the first variable, reading the updated first state, and executing the second operation based on the updated first state.

4. The computer-implemented method according to claim 2, wherein the executing the first operation and the second operation comprises: when execution of the first operation or the second operation fails, determining that execution of the first transaction fails, and ending execution of the first transaction.

5. The computer-implemented method according to claim 4, further comprising: after it is determined that execution of the first transaction fails, rolling back modification to a world state in a process of executing the first transaction.

6. The computer-implemented method according to claim 4, further comprising: generating a receipt of the first transaction, wherein the receipt comprises output information corresponding to an operation that has been executed, wherein output information corresponding to an operation whose execution fails is used to indicate error information of the operation, and output information corresponding to an operation whose execution succeeds is used to indicate a return value of the operation.

7. The computer-implemented method according to claim 6, wherein the receipt further comprises a transaction result, and the transaction result is used to indicate whether execution of the first transaction fails; and
the receipt comprises at least one piece of output information that is sequentially arranged and that correspond to at least one operation that has been executed, and an arrangement order of the at least one piece of output information is determined based on an arrangement order of operations corresponding to pieces of output information, and in a case that execution of the first transaction fails, the piece of output information arranged last is used to indicate error information of an operation corresponding to the output information.

8. The computer-implemented method according to claim 1, further comprising:
generating a read/write set of the first transaction before the first transaction is executed, wherein the read/write set comprises identifiers, obtained through analysis, of variables accessed in the first operation and the second operation; and
grouping the first transaction into a transaction group based on the read/write set, to execute transactions in each transaction group in parallel.

9. The computer-implemented method according to claim 1, wherein the first operation further comprises a first parameter input to the first function, and the second operation further comprises a second parameter input to the second function.

10. The computer-implemented method according to claim 1, wherein the first transaction further comprises a sender account, and the computer-implemented method further comprises: receiving a signature of the sender account corresponding to the first transaction.

11. A blockchain node, comprising:
one or more processors; and
one or more tangible, non-transitory, machine-readable media storing one or more instructions that, when executed by the one or more processors, perform operations comprising:
receiving a first transaction, wherein the first transaction comprises a first operation and a second operation, the first operation is used to call a first function in a first contract, and the second operation is used to call a second function in a second contract; and
executing the first operation and the second operation.

12. The blockchain node according to claim 11, wherein the first transaction further comprises an arrangement order of the first operation and the second operation, and the executing the first operation and the second operation comprises:
executing, based on the arrangement order, the first operation that is arranged ahead of the second operation; and
in a case that execution of the first operation succeeds, executing the second operation.

13. The blockchain node according to claim 11, wherein the operations comprise:
generating a read/write set of the first transaction before the first transaction is executed, wherein the read/write set comprises identifiers, obtained through analysis, of variables accessed in the first operation and the second operation; and
grouping the first transaction into a transaction group based on the read/write set, to execute transactions in each transaction group in parallel.

14. The blockchain node according to claim 11, wherein the first operation further comprises a first parameter input to the first function, and the second operation further comprises a second parameter input to the second function.

15. The blockchain node according to claim 11, wherein the first transaction further comprises a sender account, and the operations comprise: receiving a signature of the sender account corresponding to the first transaction.

16. A non-transitory, computer-readable medium storing one or more instructions executable by a computer system to perform operations comprising:
one or more processors; and
one or more tangible, non-transitory, machine-readable media storing one or more instructions that, when executed by the one or more processors, perform one or more operations comprising:
receiving a first transaction, wherein the first transaction comprises a first operation and a second operation, the first operation is used to call a first function in a first contract, and the second operation is used to call a second function in a second contract; and
executing the first operation and the second operation.

17. The non-transitory, computer-readable medium according to claim 16, wherein the first transaction further comprises an arrangement order of the first operation and the second operation, and the executing the first operation and the second operation comprises:
executing, based on the arrangement order, the first operation that is arranged ahead of the second operation; and
in a case that execution of the first operation succeeds, executing the second operation.

18. The non-transitory, computer-readable medium according to claim 16, wherein the operations comprise:
generating a read/write set of the first transaction before the first transaction is executed, wherein the read/write set comprises identifiers, obtained through analysis, of variables accessed in the first operation and the second operation; and
grouping the first transaction into a transaction group based on the read/write set, to execute transactions in each transaction group in parallel.

19. The non-transitory, computer-readable medium according to claim 16, wherein the first operation further comprises a first parameter input to the first function, and the second operation further comprises a second parameter input to the second function.

20. The non-transitory, computer-readable medium according to claim 16, wherein the first transaction further comprises a sender account, and the operations comprise: receiving a signature of the sender account corresponding to the first transaction.
